(19) United States
(12) Patent Application Publication
(10) Pub. No.: US 2020/0279219 A1
(43) Pub. Date: Sep. 3, 2020

(54) MACHINE LEARNING-BASED ANALYSIS PLATFORM

(71) Applicant: Accenture Global Solutions Limited, Dublin (IE)

(72) Inventors: Vijay Desai, San Diego, CA (US); Revathi Subramanian, San Diego, CA (US); Stewart De Soto, Escondido, CA (US); Ravi F. Prakash, Bangalore (IN)

(21) Appl. No.: 16/290,396

(22) Filed: Mar. 1, 2019

(51) Int. Cl. G06Q 10/08; G06N 20/20

(52) U.S. Cl. CPC G06Q 10/0835; G06Q 10/0838; G06N 20/20

(57) ABSTRACT

A device may receive invoice data related to multiple invoices, requisition data related to multiple requisitions, or project data related to multiple projects. The device may process the data using a feature extraction engine to identify features of the data. The device may process the data using a transformation engine to reduce a size of the data. The device may process the data using a set of machine learning models. The device may generate a set of recommendations related to at least one of: categorizing each of the multiple invoices, each of the multiple requisitions, or each of the multiple projects into one or more of multiple categories, identifying a set of possible suppliers for each of the multiple requisitions or each of the multiple projects, or identifying a set of similar projects for each of the multiple projects. The device may perform one or more actions.

### BACKGROUND

Different types of machine learning algorithms are associated with different types of data input and output and/or with different types of tasks or problems. One machine learning algorithm is a supervised, or semi-supervised, machine learning algorithm where a model is constructed from a set of data that contains both inputs and desired outputs. Another machine learning algorithm is an unsupervised machine learning algorithm where a model is constructed from a set of data that contains only inputs. Another machine learning algorithm is a reinforcement leaning algorithm where software agents are configured to take actions in an environment so as to maximize some notion of cumulative reward.

### SUMMARY

According to some implementations, a method may comprise: receiving, by a device, data, wherein the data includes at least one of: invoice data related to multiple invoices associated with an organization, requisition data related to multiple requisitions associated with the organization, or project data related to multiple projects associated with the organization; processing, by the device and after receiving the data, the data using a pre-processing technique, wherein the pre-processing technique includes at least one of: an image processing technique, or a text processing technique; processing, by the device and after processing the data using the pre-processing technique, the data using a feature extraction engine to identify features of the data; processing, by the device and after processing the data using the feature extraction engine, the data using a transformation engine to reduce a size of the data; processing, by the device and after processing the data using the transformation engine, the data using a set of machine learning models, wherein the set of machine learning models is related to at least one of: categorizing each of the multiple invoices associated with the invoice data, each of the multiple requisitions associated with the requisition data, or each of the multiple projects associated with the project data into one or more of multiple categories associated with operations of the organization, identifying a set of possible suppliers for each of the multiple requisitions associated with the requisition data or each of the multiple projects associated with the project data, or identifying a set of similar projects for each of the multiple projects associated with the project data; and performing, by the device and after processing the data using the set of machine learning models, one or more actions.

According to some implementations, a device may comprise: one or more memories; and one or more processors, communicatively coupled to the one or more memories, to: receive data, wherein the data is related to multiple invoices, multiple requisitions, or multiple projects associated with an organization; process, after receiving the data, the data using a pre-processing technique, wherein the pre-processing technique includes at least one of: an image process technique, or a text process technique; process, after processing the data using the pre-processing technique, the data using a feature extraction engine to identify features of the data; process, after processing the data using the feature extraction engine, the data using a transformation engine to reduce a size of the data; process, after processing the data using the transformation engine, the data using a set of machine learning models, wherein the set of machine learning models is related to at least one of: categorizing each of the multiple invoices, each of the multiple requisitions, or each of the multiple projects into one or more of multiple categories associated with operations of the organization, identifying a set of possible suppliers for each of the multiple requisitions or each of the multiple projects, or identifying a set of similar projects for each of the multiple projects; determine a score for the data based on output from the set of machine learning models, wherein the score identifies the one or more of the multiple categories, the set of possible suppliers, or the set of similar projects; and perform, after determining the score, one or more actions.

According to some implementations, a non-transitory computer-readable medium storing instructions, the instructions may comprise: one or more instructions that, when executed by one or more processors, cause the one or more processors to: receive data, wherein the data includes at least one of: invoice data related to multiple invoices associated with an organization, requisition data related to multiple requisitions associated with the organization, or project data related to multiple projects associated with the organization; process, after receiving the data, the data using a feature extraction engine to identify features of the data; process, after processing the data using the feature extraction engine, the data using a transformation engine to reduce a size of the data; process, after processing the data using the transformation engine, the data using a set of machine learning models; generate, after processing the data using the set of machine learning models, a set of recommendations related to at least one of: categorizing each of the multiple invoices associated with the invoice data, each of the multiple requisitions associated with the requisition data, or each of the multiple projects associated with the project data into one or more of multiple categories associated with operations of the organization, identifying a set of possible suppliers for each of the multiple requisitions associated with the requisition data or each of the multiple projects associated with the project data, or identifying a set of similar projects for each of the multiple projects associated with the project data; and perform, after generating the set of recommendations, one or more actions.

### BRIEF DESCRIPTION OF THE DRAWINGS

FIGS. 1A-2 are diagrams of one or more example implementations described herein.

FIG. 3 is a diagram of an example environment in which systems and/or methods described herein may be implemented.

FIG. 4 is a diagram of example components of one or more devices of FIG. 3.

FIGS. 5-7 are flow charts of an example process for performing a machine learning-based analysis using a machine learning-based platform.

### DETAILED DESCRIPTION

The following detailed description of example implementations refers to the accompanying drawings. The same reference numbers in different drawings may identify the same or similar elements.

An organization may generate a large volume of data related to invoices, requisitions, projects, and/or the like. For example, the organization may generate millions, billions, or more data elements for invoices, requisitions, projects, and/or the like on a daily, weekly, or monthly basis. In some cases, the data may be of such a large volume that a conventional computing device may not be capable of processing the data efficiently. For example, the volume of data may be too large to effectively store using conventional memory resources, to manipulate in real-time or near real-time, and/or the like. Additionally, or alternatively, and as another example, data generated from different systems may have inconsistencies with regard to data elements included in the data, identifiers used to identify data elements of the data, and/or the like. As a result, the data may consume significant memory resources in association with storing the data (or may be difficult or impossible to store), may consume significant processing resources in association with attempting to process the data (or may be difficult or impossible to process), and/or the like.

Some implementations described herein provide a machine learning-based procurement analysis platform that is capable of processing data related to invoices, requisitions, projects, and/or the like associated with an organization using various techniques, and may process the data to perform an analysis of the data. For example, the procurement analysis platform may process the data to reduce or eliminate inconsistencies in the data, to simplify the data (e.g., by removing extraneous data elements from the data), to compress the data (e.g., to reduce a size of the data), and/or the like, and may process the data to perform an analysis of the data. In this way, the procurement analysis platform may process the data to place the data in a form that can be stored more easily relative to not processing the data in the manner described herein, that can be used to perform an analysis more easily relative to not processing the data in the manner described herein, and/or the like. This reduces an amount of memory resources needed to store the data, thereby conserving memory resources. In addition, processing the data in the manner described herein conserves processing resources that would otherwise be consumed via unsuccessful attempts to process the data due to inconsistencies in the data, due to the volume of the data, and/or the like. Further, the procurement analysis platform provides a tool that can be used to perform an analysis of data in a manner not previously possible, such as by facilitating an analysis of thousands, millions, or more invoices, requisitions, and/or projects.

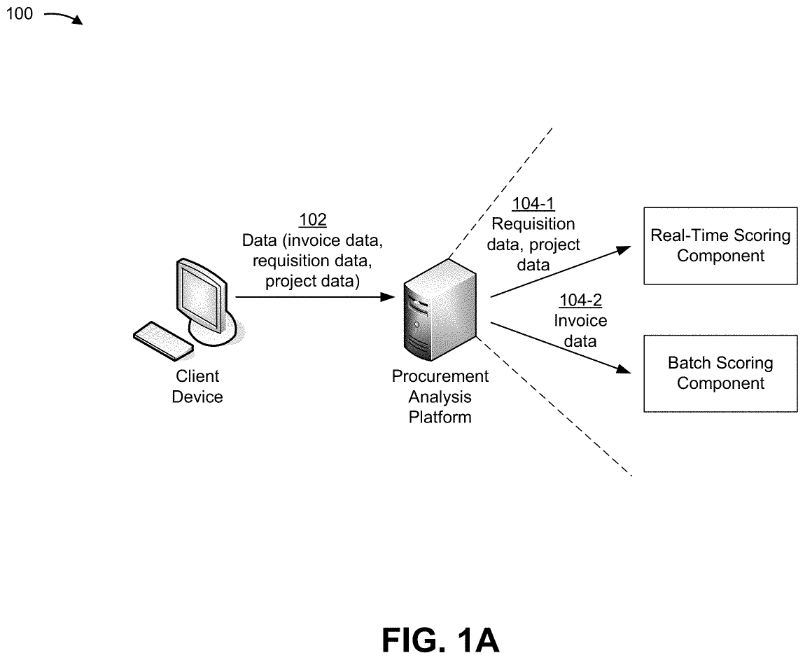

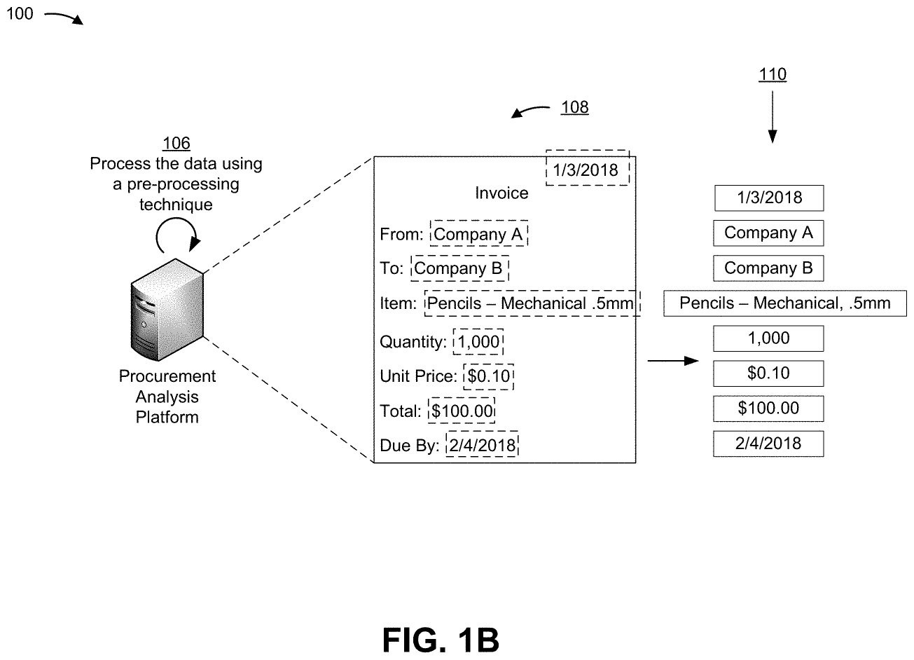

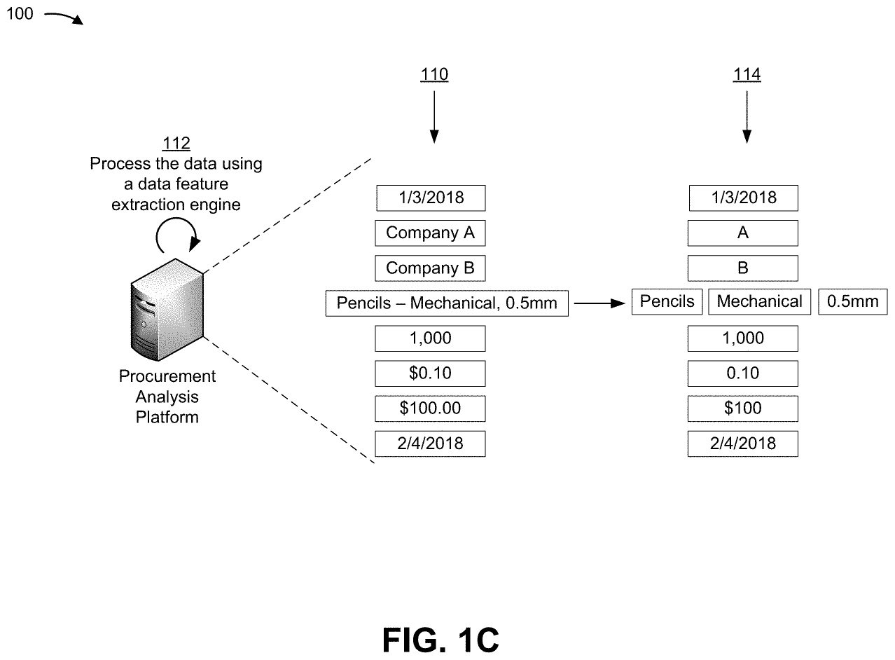

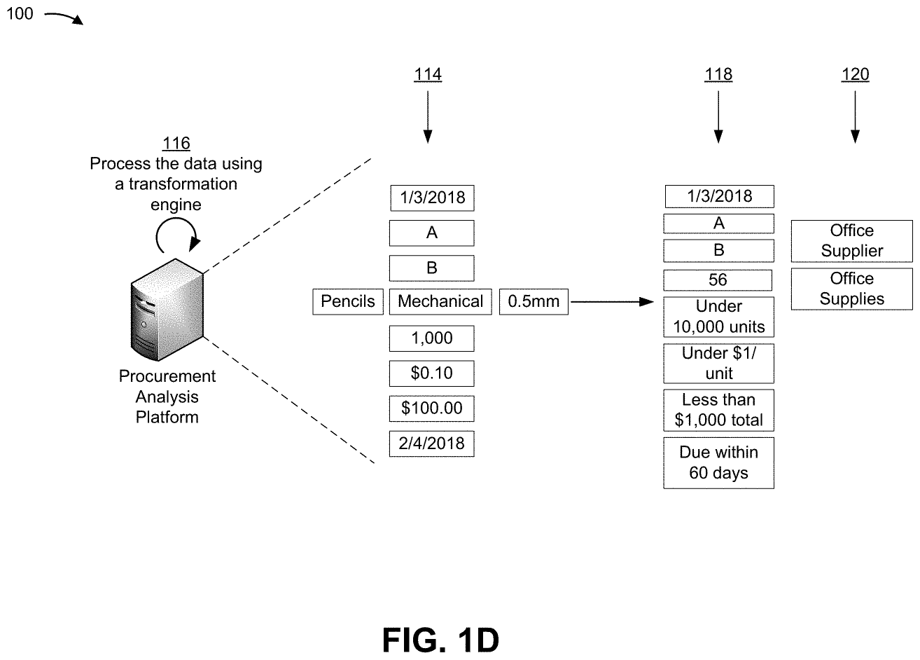

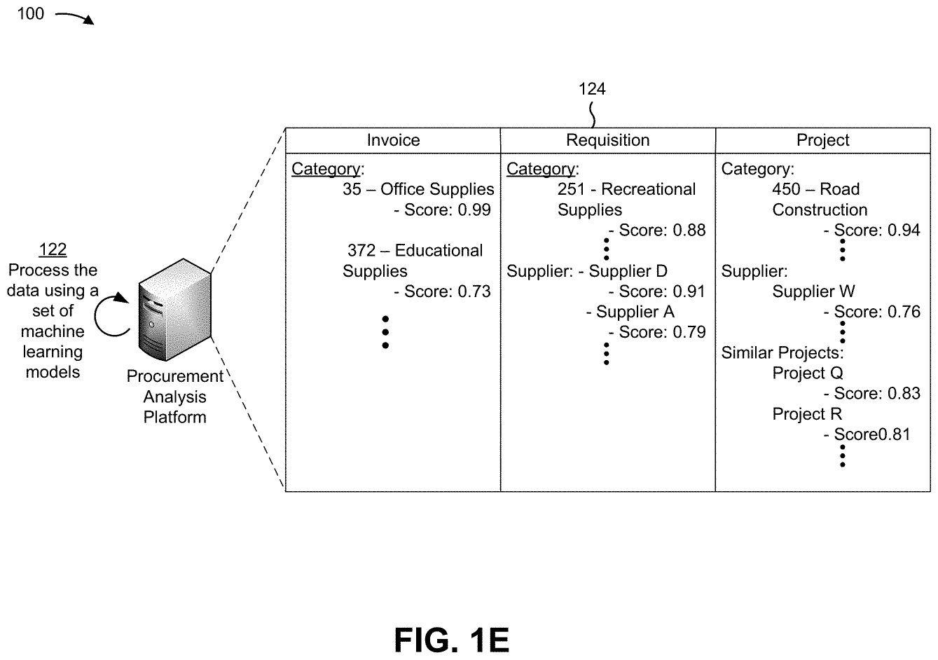

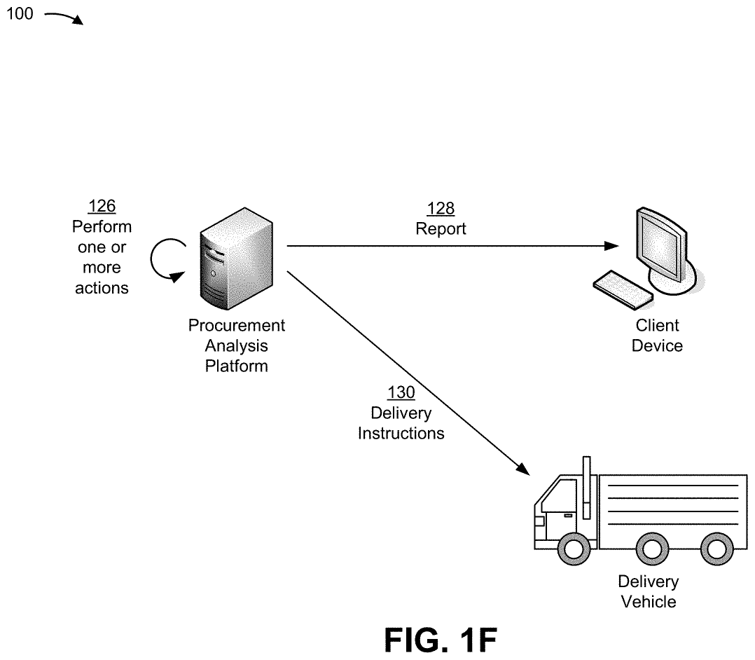

FIGS. 1A-1F are diagrams of an example implementation 100 described herein. Implementation 100 includes a client device, a procurement analysis platform, and a delivery vehicle (not shown in FIG. 1A). In some implementations, the procurement analysis platform may be a multi-tenant platform. For example, when performing operations as described herein, the procurement analysis platform may perform the operations simultaneously (or at different times) for different users of the procurement analysis platform, for different data sets, and/or the like.

As shown by reference number 102, the procurement analysis platform may receive data from a client device. For example, the procurement analysis platform may receive the data periodically, according to a schedule, based on a user of the client device inputting the data via the client device, based on requesting the data from the client device, in real-time or near real-time as the data is generated, and/or the like. In some implementations, the procurement analysis platform may receive thousands, millions, or more data elements on a daily, weekly, or monthly basis to perform an analysis with regard to invoices, requisitions, projects, and/or the like associated with an organization. In this way, the procurement analysis platform may receive a data set that cannot be processed using conventional computing resources without causing the computing resources to be overloaded, without consuming significant memory resources of the conventional computing resources, and/or the like.

In some implementations, the data may include invoice data related to invoices associated with an organization. For example, the invoice data may identify various invoices, amounts of the various invoices, items and/or services associated with the invoices, entities associated with the invoices (e.g., an organization that generated an invoice or that is receiving the invoice, an individual that generated the invoice or that is receiving the invoice, and/or the like), a date on which the invoice was generated, a date on which the invoice is due, and/or the like.

In some implementations, the data may include requisition data related to requisitions associated with the organization. For example, the requisition data may identify a date on which a requisition was generated, a date by which a requisition is to be completed, an item to be obtained via a requisition, a quantity of the item to be obtained, a budget for the requisition, and/or the like.

In some implementations, the data may include project data related to projects associated with the organization. For example, the project data may identify a project being completed by an organization, individuals staffed to a project, a duration of a project, whether a project has been completed or is on-going, whether a project is on-budget, suppliers previously used for a project, a subject matter of a project (e.g., an information technology (IT) project, a consulting project, and/or the like), and/or the like.

In some implementations, the data may be in a particular form. For example, the data may be in the form of an image, in the form of text, in the form of a spreadsheet file, and/or the like. In some implementations, and as described elsewhere herein, the procurement analysis platform may process the data using a pre-processing technique to extract terms, phrases, numbers, symbols, and/or the like from the data.

As shown by reference numbers 104-1 and 104-2, the procurement analysis platform may provide the data to various scoring components associated with the procurement analysis platform. For example, and as shown by reference number 104-1, the procurement analysis platform may provide requisition data and/or project data to a real-time scoring component for real-time (or near real-time) analysis. Additionally, or alternatively, and as another example, the procurement analysis platform may provide the invoice data to a batch scoring component for batch processing. In some implementations, the real-time scoring component and the batch scoring component may be used for different data (e.g., requisition data, project data, and/or invoice data) depending on a need for real-time (or near real-time) results, a nature of the data (e.g., some data may be generated in batch), and/or the like. In some implementations, the procurement analysis platform may provide the data to the various scoring components after receiving the data, based on receiving a request from a user of the procurement analysis platform to perform an analysis, after receiving a threshold amount of data (e.g., for data to be provided to the batch scoring component), and/or the like.

Turning to FIG. 1B, and as shown by reference number 106, the procurement analysis platform may process the data using a pre-processing technique. For example, the procurement analysis platform may use the various scoring components to process the data using the pre-processing technique after receiving the data, after providing the data to the various scoring components, and/or the like.

In some implementations, the pre-processing technique used may depend on a form of the data. For example, the procurement analysis platform may process the data using an image processing technique (e.g., a computer vision technique, an optical character recognition (OCR) technique, and/or the like) when the data is in the form of an image, may process the data using a text processing technique (e.g., a natural language processing technique, a computational linguistics technique, and/or the like) when the data is in the form of text, and/or the like.

As shown by reference number 108, and using an invoice as an example, the procurement analysis platform may process an image of the invoice to identify terms, phrases, numbers, symbols, and/or the like in the invoice. For example, the procurement analysis platform may use an image processing technique, such as an OCR technique, to identify organizations associated with the invoice (“Company A” and “Company B”), may identify items associated with the invoice (“Pencils —Mechanical 0.5 mm”), may identify a quantity of the item (“1000”), a unit price for the item (“$0.10”), a total price of the items (“$100.00”), and a due date for the invoice (“Feb. 4, 2018”), and/or the like by identifying text in the image, by searching a predefined area of the image for text, and/or the like.

As shown by reference number 110, and continuing with the invoice as an example, the procurement analysis platform may extract data from the invoice after identifying the data in the invoice. For example, the procurement analysis platform may extract terms, phrases, numbers, symbols, and/or the like from an image of the invoice after identifying the terms, phrases, numbers, symbols, and/or the like in the image. In some implementations, the procurement analysis platform may extract the identified data by copying portions of the data, by generating a snippet of the data, and/or the like. For example, the procurement analysis platform may copy identified terms, phrases, numbers, symbols, and/or the like from the image of the invoice, may capture, from the image of the invoice, an image snippet that includes the terms, phrases, numbers, symbols, and/or the like, and/or the like. Continuing with the previous example, the data shown by reference number 110 may include copied data from the image of the invoice, image snippets that include the data, and/or the like.

In some implementations, the procurement analysis platform may delete data that was not extracted. For example, the procurement analysis platform may delete an image of the invoice after extracting terms, phrase, numbers, symbols, and/or the like from the image. This conserves memory resources and/or process resources of the procurement analysis platform by reducing or eliminating a need for the procurement analysis platform to store and/or process non-extracted data.

Turning to FIG. 1C, and as shown by reference number 112, the procurement analysis platform may process the data using a data feature extraction engine. For example, the procurement analysis platform may process data identified in the image of the invoice using a data feature extraction engine after processing the data using the pre-processing technique. In some implementations, a data feature extraction engine may use a normalization technique, a tokenization technique, a text-based numeric features modeling technique, a latent feature modeling technique, and/or the like to process the data.

In some implementations, when processing the data using the data feature extraction engine, the procurement analysis platform may tokenize the data using a tokenization technique. For example, the procurement analysis platform may generate various sequences of characters from the data identified in the invoice. Continuing with the previous example, the procurement analysis platform may generate a set of multiple terms from a multi-term phrase, may contract a phrase to an acronym (or may expand an acronym), may classify data as a particular type of data and may remove a symbol from the data that indicates the classification of the data (e.g., may classify “$1.00” as a dollar amount and may tokenize “$1.00” to “1”), may remove particular terms and/or phrases from the data (e.g., may remove “, Inc.” or “Company” from data that includes an organization's name), and/or the like. This reduces a size of the data, thereby conserving memory resources of the procurement analysis platform when storing the data, thereby conserving processing resources when processing the data, and/or the like.

In some implementations, when processing the data using the data feature extraction engine, the procurement analysis platform may normalize the data using a normalization technique. For example, the procurement analysis platform may process the data to reduce or eliminate inconsistencies among the data (e.g., inconsistencies across data sets from different sources or inconsistencies with respect to a reference set of data). Continuing with the previous example, the procurement analysis platform may convert plural terms to singular terms (or vice versa), may add to and/or remove letters, punctuation, and/or the like with respect to the data (e.g., may convert “U.S.A.” to “USA”), may correct misspellings in the data, may convert a variation of a term to a common term (e.g., may convert “Comp. A” and “Company A” to “A”), and/or the like. This reduces or eliminates inconsistencies in the data, which places the data in a form that is easier for the procurement analysis platform to process during other operations of the procurement analysis platform and thereby conserves processing resources of the procurement analysis platform.

In some implementations, when processing the data using the data feature extraction engine, the procurement analysis platform may process the data using a text-based numeric features modeling technique. For example, the procurement analysis platform may generate a feature vector that describes a set of numeric features of a data element included in the data (e.g., a set of measurable properties or characteristics of the data element) and may classify the data from a species classification into a genus classification based on the feature vector (e.g., by calculating a scalar product between the feature vector and a vector of weights, and determining a classification of the data element based on a comparison of the scalar product to a threshold). For example, the procurement analysis platform may classify “scissors” and “pencil” into an “office supplies” classification, may classify “Pencils—No. 2” and “Pencils —Mechanical 0.5 mm” into a “pencils” classification, and/or the like. This simplifies the data for processing via classification of similar data into the same classification, thereby conserving processing resources of the procurement analysis platform when processing the data, thereby facilitating faster analysis of the data, and/or the like.

In some implementations, when processing the data using the feature extraction engine, the procurement analysis platform may process the data using a latent feature modeling technique. For example, the procurement analysis platform may perform a similar classification of the data as is described with regard to the text-based numeric features modeling technique. Continuing with the previous example, the procurement analysis platform may identify similarities or differences among terms, phrases, and/or the like included in the data (e.g., by identifying species terms and/or phrases related to the same genus term) and may classify similar terms together. This simplifies the data for processing via classification of similar data, thereby conserving processing resources of the procurement analysis platform when processing the data, thereby facilitating faster analysis of the data, and/or the like.

In some implementations, the procurement analysis platform may use a machine learning model in association with using the feature extraction engine. For example, the procurement analysis platform may use a machine learning model associated with the feature extraction engine to process the data in the manner described with respect to the feature extraction engine. In some implementations, the procurement analysis platform may generate a machine learning model via training of the machine learning model, may receive a trained machine learning model (e.g., that another device has trained), and/or the like. For example, the procurement analysis platform may train the machine learning model to output a prediction related to an invoice (e.g., a category of the invoice), a requisition (e.g., a category of the requisition and/or a supplier to use for the requisition), a project (e.g., a category of the project, a supplier to use for the project, and/or a set of similar projects for the project), and/or the like, as described herein.

In some implementations, the procurement analysis platform may train the machine learning model on a training set of data. For example, the training set of data may include data related to historical invoices, historical requisitions, and/or historical projects, and data that identifies historical categorizations, historical suppliers, and/or historical similar projects for the historical invoices, the historical requisitions, and the historical projects. Additionally, or alternatively, when the procurement analysis platform inputs the data related to the historical invoices, the historical requisitions, and/or the historical projects into the machine learning model, the procurement analysis platform may input a first portion of the data as a training set of data (e.g., to train a machine learning model), a second portion of the data as a validation set of data (e.g., to evaluate an effectiveness of the training of the machine learning model and/or to identify needed modifications to the training of the machine learning model), and a third portion of the data as a test set of data (e.g., to evaluate a finalized machine learning model after training and adjustments to the training using the first portion of the data and the second portion of the data). In some implementations, the procurement analysis platform may perform multiple iterations of training of the machine learning model, depending on an outcome of testing of the machine learning model (e.g., by submitting different portions of the data as the training set of data, the validation set of data, and the test set of data).

In some implementations, when training the machine learning model, the procurement analysis platform may utilize a random forest classifier technique to train the machine learning model. For example, the procurement analysis platform may utilize a random forest classifier technique to construct multiple decision trees during training and may output a classification of data. Additionally, or alternatively, when training the machine learning model, the procurement analysis platform may utilize one or more gradient boosting techniques to generate the machine learning model. For example, the procurement analysis platform may utilize an xgboost classifier technique, a gradient boosting tree, and/or the like to generate a prediction model from a set of weak prediction models.

In some implementations, when training the machine learning model, the procurement analysis platform may utilize logistic regression to train the machine learning model. For example, the procurement analysis platform may utilize a binary classification of the data related to the historical invoices, the historical requisitions, and/or the historical projects (e.g., whether the historical invoices, the historical requisitions, and/or the historical projects are associated with particular category) to train the machine learning model. Additionally, or alternatively, when training the machine learning model, the procurement analysis platform may utilize a naïve Bayes classifier to train the machine learning model. For example, the procurement analysis platform may utilize binary recursive partitioning to divide the data related to the historical invoices, the historical requisitions, and/or the historical projects into various binary categories (e.g., starting with whether the historical invoices, the historical requisitions, and/or the historical projects match a historical pattern of data). Based on using recursive partitioning, the procurement analysis platform may reduce utilization of computing resources relative to manual, linear sorting and analysis of data points, thereby enabling use of thousands, millions, or billions of data points to train a machine learning model, which may result in a more accurate machine learning model than using fewer data points.

Additionally, or alternatively, when training the machine learning model, the procurement analysis platform may utilize a support vector machine (SVM) classifier. For example, the procurement analysis platform may utilize a linear model to implement non-linear class boundaries, such as via a max margin hyperplane. Additionally, or alternatively, when utilizing the SVM classifier, the procurement analysis platform may utilize a binary classifier to perform a multi-class classification. Use of an SVM classifier may reduce or eliminate overfitting, may increase a robustness of the machine learning model to noise, and/or the like.

In some implementations, the procurement analysis platform may train the machine learning model using a supervised training procedure that includes receiving input to the machine learning model from a subject matter expert. In some implementations, the procurement analysis platform may use one or more other model training techniques, such as a neural network technique, a latent semantic indexing technique, and/or the like. For example, the procurement analysis platform may perform a multi-layer artificial neural network processing technique (e.g., using a two-layer feedforward neural network architecture, a three-layer feedforward neural network architecture, and/or the like) to perform pattern recognition with regard to patterns of historical invoices, requisitions, and/or projects, patterns of historical invoices, requisitions, and/or projects based on an accuracy of historical analyses, and/or the like. In this case, use of the artificial neural network processing technique may improve an accuracy of a supervised learning model generated by the procurement analysis platform by being more robust to noisy, imprecise, or incomplete data, and by enabling the procurement analysis platform to detect patterns and/or trends undetectable to human analysts or systems using less complex techniques.

As an example, the procurement analysis platform may use a supervised multi-label classification technique to train the machine learning model. For example, as a first step, the procurement analysis platform may map data associated with the historical invoices, requisitions, and/or projects to a set of previously generated models after labeling the historical invoices, requisitions, and/or projects. In this case, the classification of historical invoices, requisitions, and/or projects may be characterized as having been accurately or inaccurately predicted, and/or the like (e.g., by a technician, thereby reducing processing relative to the procurement analysis platform being required to analyze each historical invoice, requisition, and/or project).

As a second step, the procurement analysis platform may determine classifier chains, whereby labels of target variables may be correlated (e.g., in this example, labels may be a result of a historical classification and correlation may refer to historical classifications common to the different labels, and/or the like). In this case, the procurement analysis platform may use an output of a first label as an input for a second label (as well as one or more input features, which may be other data relating to the historical invoices, requisitions, and/or projects), and may determine a likelihood that a particular historical invoice, requisition, and/or project is to be associated with at least one classification based on a similarity to other historical invoices, requisitions, and/or projects that are associated with similar data. In this way, the procurement analysis platform transforms classification from a multilabel-classification problem to multiple single-classification problems, thereby reducing processing utilization.

As a third step, the procurement analysis platform may determine a Hamming Loss Metric relating to an accuracy of a label in performing a classification by using the validation set of the data (e.g., an accuracy with which a weighting is applied to each historical invoice, requisition, and/or project and whether each historical invoice, requisition, and/or project is associated with a particular classification, results in a correct classification, and/or the like, thereby accounting for variations among historical invoices, requisitions, and/or projects).

As a fourth step, the procurement analysis platform may finalize the machine learning model based on labels that satisfy a threshold accuracy associated with the Hamming Loss Metric, and may use the machine learning model for subsequent determination of other models.

As another example, the procurement analysis platform may determine, using a linear regression technique, that a threshold percentage of values of data elements, in a set of values of data elements, do not indicate a particular classification, whether a particular supplier should not be used for a requisition, and/or the like, and may determine that those values of data elements are to receive relatively low association scores. In contrast, the procurement analysis platform may determine that another threshold percentage of values of data elements indicates a particular classification, whether a supplier should be used for a requisition, and/or the like, and may assign a relatively high association score to those values of data elements. Based on the characteristics of the data elements indicating a classification, whether a supplier should be used, and/or the like, or not, the procurement analysis platform may generate the model and may use the model for analyzing new data elements related to invoices, requisitions, projects, and/or the like that the procurement analysis platform identifies.

Accordingly, the procurement analysis platform may use artificial intelligence techniques, machine learning techniques, deep learning techniques, and/or the like to determine a category, to determine a supplier to use, to identify similar projects, and/or the like, as described herein.

In some implementations, the procurement analysis platform may generate a model and may use the model to perform various processing described herein. For example, based on data relating to hundreds, thousands, millions or more entities across multiple systems, the procurement analysis platform may determine a categorization of an invoice, a requisition, and/or a project, may determine a supplier to use for a requisition and/or a project, and/or may identify similar projects for a project. In this case, the model may be an item-based collaborative filtering model, a single value decomposition model, a hybrid recommendation model, and/or another type of model that enables various determinations described herein based on invoice data, requisition data, project data, and/or the like.

In some implementations, the procurement analysis platform may generate different machine learning models associated with generating different predictions, associated with processing data from different systems and/or of different forms, and/or the like. In some implementations, the procurement analysis platform may input data received from a system into a machine learning model (e.g., invoice data, requisition data, project data, and/or the like), and the machine learning model may output information that identifies a predicted category for an invoice, a requisition, and/or a project, that identifies a supplier for a requisition and/or a project, that identifies a set of similar projects for a project, and/or the like. In some implementations, the procurement analysis platform may use this information to generate a recommendation for an invoice, a requisition, and/or a project, as described elsewhere herein.

Reference number 114 shows example output of processing data extracted from an invoice (shown by reference number 110) using the data feature extraction engine. For example, some of the data elements of the data shown by reference number 110 have been modified to the form shown by reference number 114. Continuing with the previous example, the data elements “Company A” and “Company B” have been modified to “A” and “B” respectively, which reduces a size of these data elements. Additionally, or alternatively, and continuing with the previous example, the phrase “Pencils —Mechanical, 0.5 mm” has been separated into the terms “Pencils,” “Mechanical,” and “0.5 mm,” while removing the “-” and “,” characters from the phrase, thereby reducing a size of the data and facilitating species and genus classification of the phrase “Pencils —Mechanical, 0.5 mm” (e.g., into a “Pencils” classification, into a “Mechanical Pencils” classification, and/or the like).

Turning to FIG. 1D, and as shown by reference number 116, the procurement analysis platform may process the data using a transformation engine. For example, the procurement analysis platform may process the data using the transformation engine after processing the data using the feature extraction engine.

In some implementations, the transformation engine may use a weak classifier technique (e.g., where subsets of the data are grouped together based on weak classifiers), a dimensionality reduction technique (e.g., where random variables in the data are reduced through feature selection and feature extraction), and/or the like. For example, the procurement analysis platform may use the transformation engine to classify the data into one or more classifications associated with generalizing the data. This reduces a quantity of unique data elements that the procurement analysis platform has to process, facilitates improved detection of characteristics of the data, and/or the like. Additionally, or alternatively, the transformation engine may include use of a function to compress the data. For example, the function may include a hash function, a checksum, and/or the like. This reduces a size of the data (e.g., from a string of characters to a shorter length hash, checksum, and/or the like), thereby conserving memory resources of the procurement analysis platform when the data is stored, conserving processing resources of the procurement analysis platform when processing the data, and/or the like. In some implementations, the procurement analysis platform may use a machine learning model, similar to that described elsewhere herein, when using the transformation engine.

Reference numbers 118 and 120 show a result of processing output from the feature extraction engine (shown by reference number 114) using a transformation engine. For example, and as shown by reference number 118, the procurement analysis platform may convert the terms “Pencil” “Mechanical,” and “0.5 mm” to the hash “56” using a hash function, may classify the number “1,000” in an “Under 10,000 units” classification, may classify the due date “Feb. 4, 2018” into a “Due within 60 days” classification based on the due date being within 60 days of the invoice date (“Jan. 3, 2018”), and/or the like. This reduces a complexity of the data and/or a size of the data, thereby conserving processing resources of the procurement analysis platform when processing the data, conserving memory resources when storing the data, and/or the like.

Continuing with the previous example, and as shown by reference number 120, the procurement analysis platform may classify “B,” which identifies Company B, into an “Office Supplier” classification, and may classify “56” into a “Office Supplies” classification. This facilitates generation of recommendations related to the data based on historical data with similar classifications.

Turning to FIG. 1E, and as shown by reference number 122, the procurement analysis platform may process the data using a set of machine learning models. For example, the procurement analysis platform may process the data using the set of machine learning models after processing the data using the transformation engine. In some implementations, the set of machine learning models may be similar to that described elsewhere herein. In some implementations, the set of machine learning models may include a gradient boosting machine learning model (e.g., that uses a prediction model in the form of an ensemble of weak prediction models, such as a decision tree), a generalized linear model (e.g., that uses a linear regression model that allows for response variables that have error distribution models other than a normal distribution), and/or the like.

In some implementations, the set of machine learning models may be associated with categorizing an invoice, a requisition, and/or a project into a category based on a context, a subject matter, and/or the like associated with the invoice, the requisition, and/or the project (e.g., an office supplies category, a recreational supplies category, an IT project category, a consulting project category, and/or the like). For example, the procurement analysis platform may use the set of machine learning models to generate a score that indicates a confidence that data extracted from an invoice, a requisition, and/or a project matches data (e.g., within a threshold) associated with a particular category. Continuing with the previous example, the procurement analysis platform may use the set of machine learning models to generate a score for each of multiple categories for an invoice, a requisition, and/or a project, and may categorize the invoice, the requisition, and/or the project based on the highest relative score, the lowest relative score, a highest average score or a lowest average score over multiple iterations of using the set of machine learning models, and/or the like. In some implementations, the procurement analysis platform may use the set of machine learning models to determine a supplier for a requisition and/or a project (e.g., a supplier to use for the requisition and/or the project), to identify similar projects for a project, and/or the like in a similar manner.

Reference number 124 shows an example of output from the set of machine learning models with respect to an invoice, a requisition, and/or a project. For example, and with respect to an invoice, the output from the set of machine learning models may identify various categories for which the invoice was evaluated, and corresponding scores associated with the various categories. Continuing with the previous example, the set of machine learning models may output a high score of 0.99 for the category “Office Supplies,” indicating that the invoice is most likely associated with office supplies. This facilitates analysis of the invoice in the context of other invoices associated with the same category, as described elsewhere herein.

Additionally, or alternatively, and as an example with respect to a requisition, the output from the set of machine learning models may identify similar scores for various categories and for various suppliers. Continuing with the previous example, and with respect to the scores for the various suppliers, the set of machine learning models may output a high score of 0.91 for supplier “D.” This may indicate that supplier “D” is the supplier most likely to be ideal for the requisition, thereby facilitating selection of a supplier for the requisition, as described elsewhere herein.

Additionally, or alternatively, and as an example with regard to a project, the output from the set of machine learning models may identify similar scores for various categories, various suppliers, and various other projects. Continuing with the previous example, and with respect to the scores for the various other projects, the set of machine learning models may output a high score of 0.83 for project “Q,” indicating that “Q” is most similar to the project. This facilitates analysis of the project in a context of one or more other similar projects, facilitates monitoring of the project in a context of the one or more other similar projects, and/or the like.

Turning to FIG. 1F, and as shown by reference number 126, the procurement analysis platform may perform one or more actions. For example, the procurement analysis platform may perform the one or more actions after processing the data using the set of machine learning models, based on output from the set of machine learning models, and/or the like.

In some implementations, the procurement analysis platform may receive, from a user of the procurement analysis platform, a manual adjustment to the output from the set of machine learning models (e.g., a recategorization of an invoice, a requisition, and/or a project) and the procurement analysis platform may update the set of machine learning models based on the manual adjustment. For example, the procurement analysis platform may retrain the set of machine learning models based on the manual adjustment, may generate a user-specific set of machine learning models, and/or the like.

Additionally, or alternatively, the procurement analysis platform may perform an analysis based on the output of the set of machine learning models. For example, the procurement analysis platform may perform an analysis of an invoice. Continuing with the previous example, the procurement analysis platform may analyze whether an amount, a due date, an item, a quantity of the item, and/or the like matches other invoices in the same category into which the invoice was categorized. Additionally, or alternatively, and as another example, the procurement analysis platform may perform an analysis of a requisition. Continuing with the previous example, the procurement analysis platform may perform a similar analysis related to a category into which the requisition was categorized and/or may perform an analysis of a supplier identified for the requisition (e.g., whether similar requisitions are associated with the supplier based on items, amounts, quantities, and/or the like associated with the requisition and the similar requisitions). Additionally, or alternatively, and as another example, the procurement analysis platform may perform an analysis of a project. Continuing with the previous example, the procurement analysis platform may perform an analysis of a category and/or a supplier for a project similar to that described elsewhere herein, and may perform an analysis of the project in a context of similar projects identified for the project (e.g., whether a budget usage and/or cost of the project matches the similar projects, whether the duration of the project matches the similar projects, and/or the like).

As another example of an analysis that the procurement analysis platform may perform, the procurement analysis platform may perform a vendor rationalization and/or recommendation analysis. For example, the procurement analysis platform may perform the vendor rationalization and/or recommendation analysis to identify inefficiencies in a combination of vendors used for supplies for a project, ways in which to reduce costs associated with using different vendors, and/or the like. Continuing with the previous example, the procurement analysis platform may analyze whether a unit price for an item can be lower based on switching vendors, may recommend a new vendor for an item, and/or the like. Additionally, or alternatively, the procurement analysis platform may determine a percentage of purchase orders and/or expenses and a corresponding quantity of vendors by purchase order count, a quantity of vendors by purchase order expenses, and/or the like. For example, the procurement analysis platform may determine a quantity of vendors associated with 10 percent, 20 percent, 30 percent, and so on of the total quantity of purchase orders and/or the total amount of purchase order expenses. Similarly, the procurement analysis platform may make similar determinations for a vendor (e.g., a percentage of the total quantity of purchase orders associated with the vendor, a percentage of a total amount of purchase order expenses associated with the vendor, and/or the like).

Based on these analyses, the procurement analysis platform may recommend modifications to combinations of vendors used. For example, the procurement analysis platform may recommend consolidating a group of vendors into a smaller quantity of vendors (or expanding a group of vendors used into a larger quantity of vendors), may recommend replacing one or more vendors with one or more other vendors, and/or the like.

Additionally, or alternatively, and as another example of an analysis that the procurement analysis platform may perform, the procurement analysis platform may perform an analysis related to price compliance for various vendors. For example, the procurement analysis platform may identify items that are associated with a price that is more than a threshold amount over a predicted amount, can identify trends in price increases or decreases (and can trigger an alarm if these trends differ from what is expected), and/or the like.

In some implementations, performing an analysis related to price compliance may include selecting and/or receiving data for a set of purchase orders received during a time period. Additionally, or alternatively, performing the analysis may include applying line item filters to the purchase orders. For example, the procurement analysis platform may filter line items of a purchase order where descriptive data about the line items is missing, may filter particular types of line items (e.g., particular types of items), may filter zero quantity or zero value line items, and/or the like. Additionally, or alternatively, performing the analysis may include performing a product identification (e.g., using a machine learning model). For example, the procurement analysis platform may identify unique products associated with the purchase orders (e.g., based on text of a purchase order, an item description in a purchase order for a product, an identifier for a product, and/or the like). This facilitates identification of similar products regardless of a consistency of text, or other descriptors, across different purchase orders, reduces an amount of unique data points that need to be processed (thereby conserving processing resources and/or memory resources of the procurement analysis platform), facilitates identification of price variations among similar products (which can facilitate expense savings), and/or the like.

Additionally, or alternatively, the analysis may include applying a product filter to the products identified in the purchase orders and/or may cluster products into various groups. For example, the procurement analysis platform may filter products that are not purchased at a threshold frequency, may filter products that experience a threshold variation in price, may filter products that are purchased in a quantity that fails to satisfy a threshold, may cluster similar products based on price, and/or the like. This facilitates a more accurate analysis of purchase orders by removing outlier data, by grouping data into easily analyzed groups (which facilitates faster analysis, conserves processing resources, and/or the like), and/or the like. Additionally, or alternatively, the procurement analysis platform may perform the analysis related to price compliance. For example, the procurement analysis platform may forecast prices for products, may make a recommendation regarding the best time to purchase a product and/or an optimal quantity of a product to purchase (based on the timing of historical fluctuations in prices for the product, based on historical discounts applied to historical bulk orders, and/or the like), may identify prices that fail to match historical prices or predicted prices, and/or the like. Continuing with the previous example, the procurement analysis platform may identify a price as being non-compliant if the price exceeds a historical or predicted price by a threshold amount, may identify a price as being a likely data error if the price exceeds a historical or predicted price by a threshold amount, and/or the like.

In some implementations, the procurement analysis platform may perform a cluster analysis in association with performing the analysis related to the price compliance. For example, the procurement analysis platform may cluster products by unit price, date of purchase, and/or the like. Performing a cluster analysis may reduce a quantity of line items flagged incorrectly as non-compliant (e.g., based on being in a particular cluster), which conserves processing resources associated with flagging line items and/or reduces or eliminates a need for a manual review of flags, can facilitate identification of consistent or inconsistent price changes over time, and/or the like. In some implementations, the procurement analysis platform may update clustering based on changes to vendors used, to a time period for purchase orders use, to a purchase location, to a set of purchase orders analyzed, and/or the like. Additionally, or alternatively, the procurement analysis platform may utilize an adjustable look-back period to account for volatile prices. For example, the procurement analysis platform may analyze purchase orders on a rolling basis using a 10-day, 90-day, and/or the like time period.

In some implementations, the procurement analysis platform may train a machine learning model on historical trends in price data and/or discounts to facilitate performance of an analysis related to price compliance. This improves an accuracy of identifying non-compliant prices, thereby conserving processing resources that would otherwise be consumed as a result of inaccurately identifying non-compliant prices.

Additionally, or alternatively, and as shown by reference number 128, the procurement analysis platform may output a report for display (e.g., by providing the report to the client device). For example, the report may include information that identifies a result of an analysis, that includes output from the set of machine learning models, and/or the like.

In some implementations, the procurement analysis platform may generate a recommendation. For example, the procurement analysis platform may generate a recommendation based on output from the set of machine learning models and/or based on a result of an analysis. Continuing with the previous example, the procurement analysis platform may generate a recommended modification to an invoice, a requisition, and/or a project (e.g., to match characteristics of a category into which the invoice, the requisition, and/or the project were categorized), may recommend a particular supplier to use for a requisition and/or a project (or a modification to a current supplier), may send an electronic order to a procurement system associated with the supplier to place an order for an item, may recommend a modification to the manner in which a project is managed (e.g., may recommend project crashing to accelerate a completion of the project, may recommend a modification to expenses associated with the project to keep the project under budget or at budget), and/or the like. In some implementations, the procurement analysis platform may output, for display, information that identifies a recommendation that the procurement analysis platform generated.

Additionally, or alternatively, and as shown by reference number 130, the procurement analysis platform may send, to a delivery vehicle (e.g., an on-board system, a user device associated with the delivery vehicle and/or the like), a set of delivery instructions. For example, the set of delivery instructions may identify a delivery location for an item associated with an invoice, a requisition, and/or a project. Additionally, or alternatively, the procurement analysis platform may send a message to a server device to credit an account and/or to debit an account based on an amount identified in an invoice or in a requisition. Additionally, or alternatively, the procurement analysis platform may send a message to a server device to update an account regarding the status of an invoice (e.g., whether the invoice has been received, processed, and/or paid), a requisition (e.g., whether the requisition has been sent, confirmed by a supplier, and/or fulfilled), and/or a project (e.g., whether a project is on time, on budget, and/or the like).

In this way, the procurement analysis platform may process data to reduce a size of the data and/or to simplify the data. This reduces an amount of memory resources needed to store the data, thereby conserving memory resources of the procurement analysis platform. In addition, processing the data in this manner facilitates faster processing of the data relative to using an unprocessed data set. Further, processing the data in this manner places the data in a form that reduces a computing load on the processing resources when processing the data.

As indicated above, FIGS. 1A-1F are provided merely as one or more examples. Other examples may differ from what is described with regard to FIGS. 1A-1F.

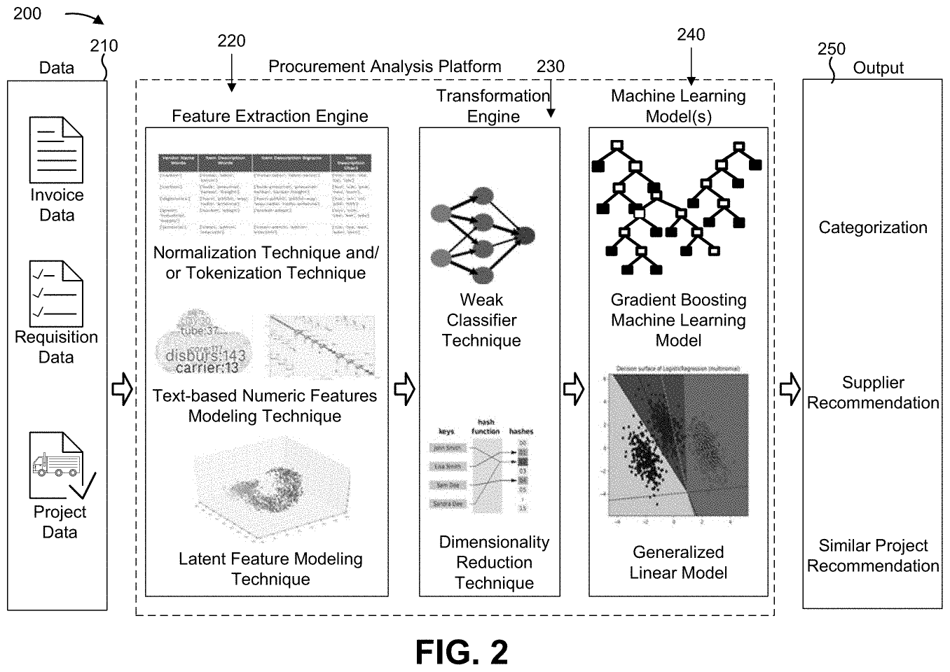

FIG. 2 is a diagram of an example implementation 200 described herein. Implementation 200 includes a procurement analysis platform.

As shown by reference number 210, the procurement analysis platform may receive data in a manner similar to that described elsewhere herein. For example, the procurement analysis platform may receive invoice data, requisition data, and/or project data. As shown by reference number 220, the procurement analysis platform may process the data using a feature extraction engine in a manner similar to that described elsewhere herein. For example, the procurement analysis platform may process the data using a normalization technique (e.g., word normalization), a tokenization technique (e.g., tokenization stemming), a text-based numeric features modeling technique (e.g., logarithmic tf-idf), a latent feature modeling technique (e.g., word2vec, GloVe vectors), and/or the like.

As shown by reference number 230, the procurement analysis platform may process output from the feature extraction engine using a transformation engine in a manner similar to that described elsewhere herein. For example, the procurement analysis platform may process the output from the feature extraction engine using a weak classifier technique, a dimensionality reduction technique (e.g., using feature hashing), and/or the like. As shown by reference number 240, the procurement analysis platform may process output from the transformation engine using a set of machine learning models in a manner that is similar to that described elsewhere herein. For example, the procurement analysis platform may process the output from the transformation engine using a gradient boosting machine learning model, a generalized linear model, and/or the like. As shown by reference number 250, output from the set of machine learning models may be similar to that described elsewhere herein. For example, the output from the set of machine learning models may include a categorization, a supplier recommendation, a similar project recommendation, and/or the like.

As indicated above, FIG. 2 is provided merely as an example. Other examples may differ from what is described with regard to FIG. 2.

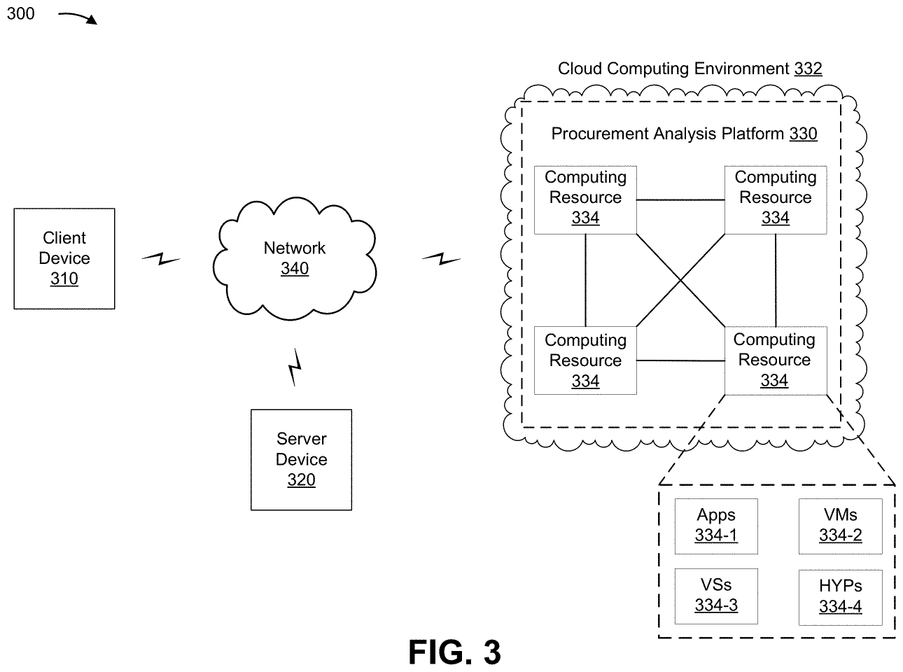

FIG. 3 is a diagram of an example environment 300 in which systems and/or methods described herein may be implemented. As shown in FIG. 3, environment 300 may include a client device 310, a server device 320, a procurement analysis platform 330 hosted within a cloud computing environment 332 that includes a set of computing resources 334, and a network 340. Devices of environment 300 may interconnect via wired connections, wireless connections, or a combination of wired and wireless connections.

Client device 310 includes one or more devices capable of receiving, generating, storing, processing, and/or providing data described herein. For example, client device 310 may include a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, and/or the like), a desktop computer, or a similar type of device. In some implementations, client device 310 may receive, from procurement analysis platform 330, a result of an analysis of data performed by procurement analysis platform 330, as described elsewhere herein.

Server device 320 includes one or more devices capable of receiving, generating storing, processing, and/or providing data described herein. For example, server device 320 may include a server (e.g., in a data center or a cloud computing environment), a data center (e.g., a multi-server micro datacenter), a workstation computer, a virtual machine (VM) provided in a cloud computing environment, or a similar type of device. In some implementations, server device 320 may include a communication interface that allows server device 320 to receive information from and/or transmit information to other devices in environment 300. In some implementations, server device 320 may be a physical device implemented within a housing, such as a chassis. In some implementations, server device 320 may be a virtual device implemented by one or more computer devices of a cloud computing environment or a data center. In some implementations, server device 320 may provide, to procurement analysis platform 330, data for processing by procurement analysis platform 330, as described elsewhere herein.

Procurement analysis platform 330 includes one or more devices capable of receiving, generating, storing, processing, and/or providing data described herein. For example, procurement analysis platform 330 may include a cloud server or a group of cloud servers. In some implementations, procurement analysis platform 330 may be designed to be modular such that certain software components can be swapped in or out depending on a particular need. As such, procurement analysis platform 330 may be easily and/or quickly reconfigured for different uses.

In some implementations, as shown in FIG. 3, procurement analysis platform 330 may be hosted in cloud computing environment 332. Notably, while implementations described herein describe procurement analysis platform 330 as being hosted in cloud computing environment 332, in some implementations, procurement analysis platform 330 may be non-cloud-based (i.e., may be implemented outside of a cloud computing environment) or may be partially cloud-based.

Cloud computing environment 332 includes an environment that hosts procurement analysis platform 330. Cloud computing environment 332 may provide computation, software, data access, storage, and/or other services that do not require end-user knowledge of a physical location and configuration of a system and/or a device that hosts procurement analysis platform 330. As shown, cloud computing environment 332 may include a group of computing resources 334 (referred to collectively as “computing resources 334” and individually as “computing resource 334”).

Computing resource 334 includes one or more personal computers, workstation computers, server devices, or another type of computation and/or communication device. In some implementations, computing resource 334 may host procurement analysis platform 330. The cloud resources may include compute instances executing in computing resource 334, storage devices provided in computing resource 334, data transfer devices provided by computing resource 334, etc. In some implementations, computing resource 334 may communicate with other computing resources 334 via wired connections, wireless connections, or a combination of wired and wireless connections.

As further shown in FIG. 3, computing resource 334 may include a group of cloud resources, such as one or more applications (“APPs”) 334-1, one or more virtual machines (“VMs”) 334-2, one or more virtualized storages (“VSs”) 334-3, or one or more hypervisors (“HYPs”) 334-4.

Application 334-1 includes one or more software applications that may be provided to or accessed by one or more devices of environment 300. Application 334-1 may eliminate a need to install and execute the software applications on devices of environment 300. For example, application 334-1 may include software associated with procurement analysis platform 330 and/or any other software capable of being provided via cloud computing environment 332. In some implementations, one application 334-1 may send/receive information to/from one or more other applications 334-1, via virtual machine 334-2. In some implementations, application 334-1 may include a software application associated with one or more databases and/or operating systems. For example, application 334-1 may include an enterprise application, a functional application, an analytics application, and/or the like.

Virtual machine 334-2 includes a software implementation of a machine (e.g., a computer) that executes programs like a physical machine. Virtual machine 334-2 may be either a system virtual machine or a process virtual machine, depending upon use and degree of correspondence to any real machine by virtual machine 334-2. A system virtual machine may provide a complete system platform that supports execution of a complete operating system (“OS”). A process virtual machine may execute a single program, and may support a single process. In some implementations, virtual machine 334-2 may execute on behalf of a user (e.g., a user of client device 310), and may manage infrastructure of cloud computing environment 332, such as data management, synchronization, or long-duration data transfers.

Virtualized storage 334-3 includes one or more storage systems and/or one or more devices that use virtualization techniques within the storage systems or devices of computing resource 334. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 334-4 provides hardware virtualization techniques that allow multiple operating systems (e.g., “guest operating systems”) to execute concurrently on a host computer, such as computing resource 334. Hypervisor 334-4 may present a virtual operating platform to the guest operating systems, and may manage the execution of the guest operating systems. Multiple instances of a variety of operating systems may share virtualized hardware resources.

Network 340 includes one or more wired and/or wireless networks. For example, network 340 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 3 are provided as one or more examples. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

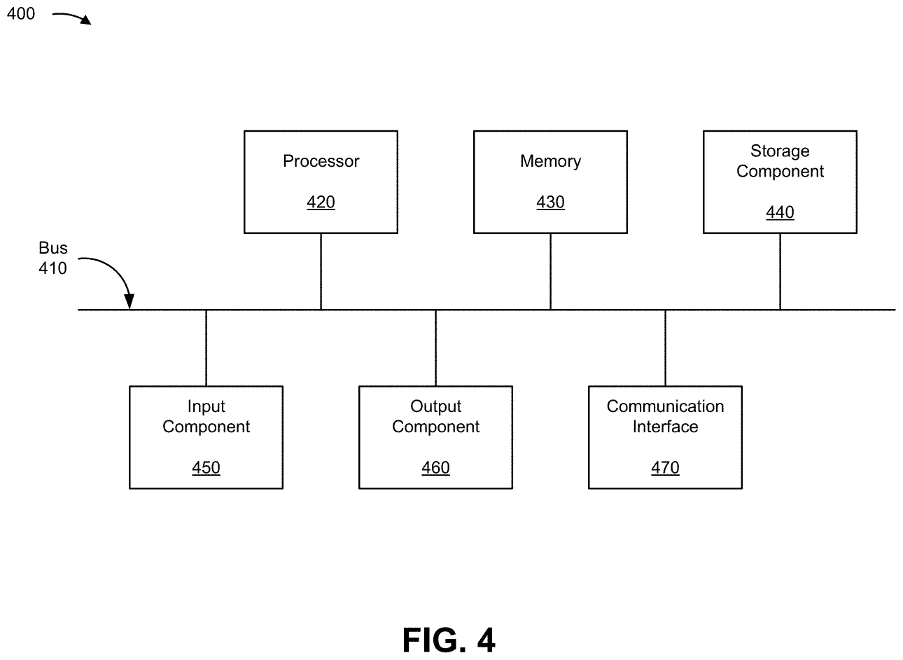

FIG. 4 is a diagram of example components of a device 400. Device 400 may correspond to client device 310, server device 320, procurement analysis platform 330, and/or computing resource 334. In some implementations, client device 310, server device 320, procurement analysis platform 330, and/or computing resource 334 may include one or more devices 400 and/or one or more components of device 400. As shown in FIG. 4, device 400 may include a bus 410, a processor 420, a memory 430, a storage component 440, an input component 450, an output component 460, and a communication interface 470.

Bus 410 includes a component that permits communication among multiple components of device 400. Processor 420 is implemented in hardware, firmware, and/or a combination of hardware and software. Processor 420 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 420 includes one or more processors capable of being programmed to perform a function. Memory 430 includes a random access memory (RAM), a read only memory (ROM), and/or another type of dynamic or static storage device (e.g., a flash memory, a magnetic memory, and/or an optical memory) that stores information and/or instructions for use by processor 420.

Storage component 440 stores information and/or software related to the operation and use of device 400. For example, storage component 440 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 450 includes a component that permits device 400 to receive information, such as via user input (e.g., a touch screen display, a keyboard, a keypad, a mouse, a button, a switch, and/or a microphone). Additionally, or alternatively, input component 450 may include a component for determining location (e.g., a global positioning system (GPS) component) and/or a sensor (e.g., an accelerometer, a gyroscope, an actuator, another type of positional or environmental sensor, and/or the like). Output component 460 includes a component that provides output information from device 400 (via, e.g., a display, a speaker, a haptic feedback component, an audio or visual indicator, and/or the like).

Communication interface 470 includes a transceiver-like component (e.g., a transceiver, a separate receiver, a separate transmitter, and/or the like) that enables device 400 to communicate with other devices, such as via a wired connection, a wireless connection, or a combination of wired and wireless connections. Communication interface 470 may permit device 400 to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, and/or the like.

Device 400 may perform one or more processes described herein. Device 400 may perform these processes based on processor 420 executing software instructions stored by a non-transitory computer-readable medium, such as memory 430 and/or storage component 440. As used herein, the term “computer-readable medium” refers to a non-transitory memory device. A memory device includes memory space within a single physical storage device or memory space spread across multiple physical storage devices.

Software instructions may be read into memory 430 and/or storage component 440 from another computer-readable medium or from another device via communication interface 470. When executed, software instructions stored in memory 430 and/or storage component 440 may cause processor 420 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

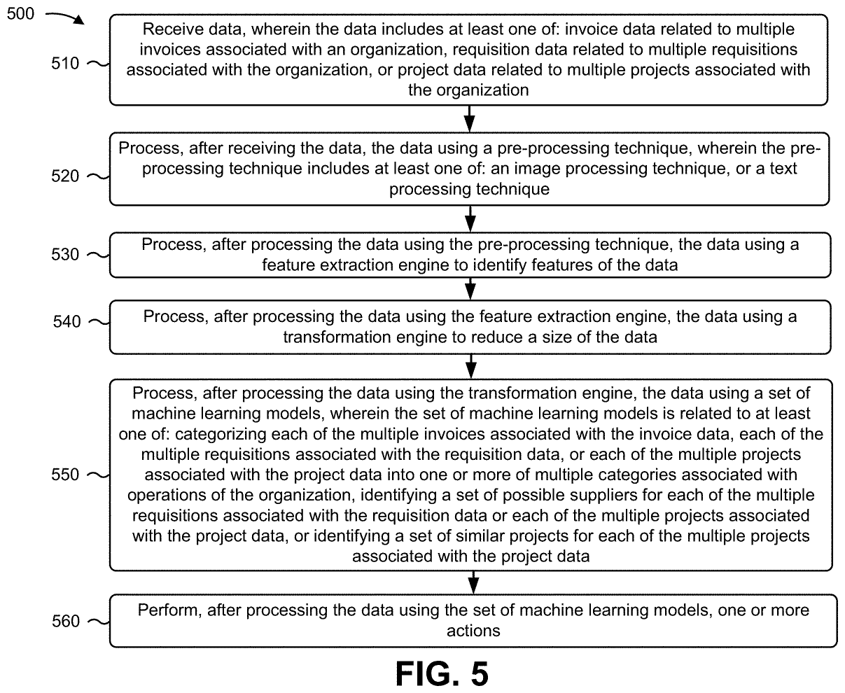

FIG. 5 is a flow chart of an example process 500 for performing machine learning-based analysis using a machine learning-based platform. In some implementations, one or more process blocks of FIG. 5 may be performed by a procurement analysis platform (e.g., procurement analysis platform 330). In some implementations, one or more process blocks of FIG. 5 may be performed by another device or a group of devices separate from or including the procurement analysis platform, such as a client device (e.g., client device 310), a server device (e.g., server device 320), and a computing resource (e.g., computing resource 334).

As shown in FIG. 5, process 500 may include receiving data, wherein the data includes at least one of: invoice data related to multiple invoices associated with an organization, requisition data related to multiple requisitions associated with the organization, or project data related to multiple projects associated with the organization (block 510). For example, the procurement analysis platform (e.g., using computing resource 334, processor 420, input component 450, communication interface 470, and/or the like) may receive data, as described above. In some implementations, the data includes at least one of: invoice data related to multiple invoices associated with an organization, requisition data related to multiple requisitions associated with the organization, or project data related to multiple projects associated with the organization.

As further shown in FIG. 5, process 500 may include processing, after receiving the data, the data using a pre-processing technique, wherein the pre-processing technique includes at least one of: an image processing technique, or a text processing technique (block 520). For example, the procurement analysis platform (e.g., using computing resource 334, processor 420, and/or the like) may process, after receiving the data, the data using a pre-processing technique, as described above. In some implementations, the pre-processing technique includes at least one of: an image processing technique, or a text processing technique.

As further shown in FIG. 5, process 500 may include processing, after processing the data using the pre-processing technique, the data using a feature extraction engine to identify features of the data (block 530). For example, the procurement analysis platform (e.g., using computing resource 334, processor 420, and/or the like) may process, after processing the data using the pre-processing technique, the data using a feature extraction engine to identify features of the data, as described above.

As further shown in FIG. 5, process 500 may include processing, after processing the data using the feature extraction engine, the data using a transformation engine to reduce a size of the data (block 540). For example, the procurement analysis platform (e.g., using computing resource 334, processor 420, and/or the like) may process, after processing the data using the feature extraction engine, the data using a transformation engine to reduce a size of the data.

As further shown in FIG. 5, process 500 may include processing, after processing the data using the transformation engine, the data using a set of machine learning models, wherein the set of machine learning models is related to at least one of: categorizing each of the multiple invoices associated with the invoice data, each of the multiple requisitions associated with the requisition data, or each of the multiple projects associated with the project data into one or more of multiple categories associated with operations of the organization, identifying a set of possible suppliers for each of the multiple requisitions associated with the requisition data or each of the multiple projects associated with the project data, or identifying a set of similar projects for each of the multiple projects associated with the project data (block 550). For example, the procurement analysis platform (e.g., using computing resource 334, processor 420, and/or the like) may process, after processing the data using the transformation engine, the data using a set of machine learning models, as described above. In some implementations, the set of machine learning models is related to at least one of: categorizing each of the multiple invoices associated with the invoice data, each of the multiple requisitions associated with the requisition data, or each of the multiple projects associated with the project data into one or more of multiple categories associated with operations of the organization, identifying a set of possible suppliers for each of the multiple requisitions associated with the requisition data or each of the multiple projects associated with the project data, or identifying a set of similar projects for each of the multiple projects associated with the project data.

As further shown in FIG. 5, process 500 may include performing, after processing the data using the set of machine learning models, one or more actions (block 560). For example, the procurement analysis platform (e.g., using computing resource 334, processor 420, memory 430, storage component 440, input component 450, output component 460, communication interface 470, and/or the like) may perform, after processing the data using the set of machine learning models, one or more actions, as described above.

Process 500 may include additional implementations, such as any single implementation or any combination of implementations described below and/or in connection with one or more other processes described elsewhere herein.

In some implementations, the procurement analysis platform may determine a set of scores for each of the multiple invoices, each of the multiple requisitions, or each of the multiple projects based on output from the set of machine learning models, wherein the set of scores indicates at least one of: the one or more of the multiple categories into which each of the multiple invoices, each of the multiple requisitions, or each of the multiple projects are to be categorized, the set of possible suppliers for each of the multiple requisitions or each of the multiple projects, or the set of similar projects for each of the multiple projects. In some implementations, the procurement analysis platform may generate, based on the set of scores, a set of recommendations related to at least one of: categorizing the multiple invoices, identifying the set of possible suppliers, identifying the set of similar projects, or performing the one or more actions.

In some implementations, the set of machine learning models includes at least one of: a gradient boosting machine learning model, or a generalized linear model. In some implementations, the procurement analysis platform may generate a report that includes information identifying at least one of: the one or more of the multiple categories, the set of possible suppliers, or the set of similar projects, and may output, after generating the report, the report for display via a client device.

In some implementations, the procurement analysis platform may select a supplier, of the set of possible suppliers, based on a respective score associated with the set of possible suppliers, wherein the respective score is output from the set of machine learning models, and may send, to a procurement system associated with the supplier, an electronic order for one or more items after selecting the supplier. In some implementations, the procurement analysis platform may send, to a vehicle associated with delivering the one or more items, information that identifies a delivery location for the one or more items.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

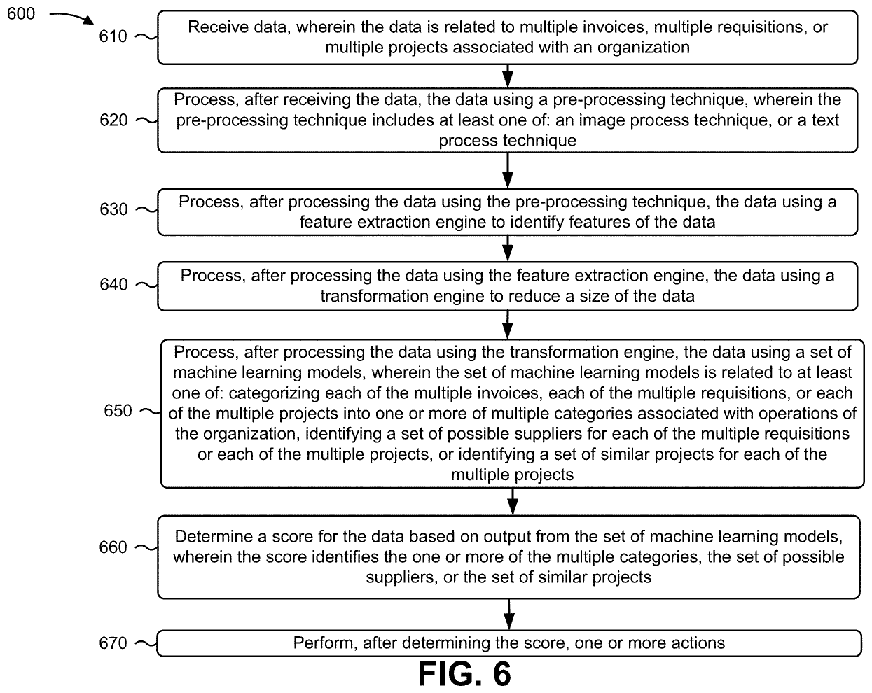

FIG. 6 is a flow chart of an example process 600 for performing machine learning-based analysis using a machine learning-based platform. In some implementations, one or more process blocks of FIG. 6 may be performed by a procurement analysis platform (e.g., procurement analysis platform 330). In some implementations, one or more process blocks of FIG. 6 may be performed by another device or a group of devices separate from or including the procurement analysis platform, such as a client device (e.g., client device 310), a server device (e.g., server device 320), and a computing resource (e.g., computing resource 334).

As shown in FIG. 6, process 600 may include receiving data, wherein the data is related to multiple invoices, multiple requisitions, or multiple projects associated with an organization (block 610). For example, the procurement analysis platform (e.g., using computing resource 334, processor 420, input component 450, communication interface 470, and/or the like) may receive data, as described above. In some implementations, the data is related to multiple invoices, multiple requisitions, or multiple projects associated with an organization.

As further shown in FIG. 6, process 600 may include processing, after receiving the data, the data using a pre-processing technique, wherein the pre-processing technique includes at least one of: an image process technique, or a text process technique (block 620). For example, the procurement analysis platform (e.g., using computing resource 334, processor 420, and/or the like) may process, after receiving the data, the data using a pre-processing technique, as described above. In some implementations, the pre-processing technique includes at least one of: an image process technique, or a text process technique.

As further shown in FIG. 6, process 600 may include processing, after processing the data using the pre-processing technique, the data using a feature extraction engine to identify features of the data (block 630). For example, the procurement analysis platform (e.g., using computing resource 334, processor 420, and/or the like) may process, after processing the data using the pre-processing technique, the data using a feature extraction engine to identify features of the data, as described above.

As further shown in FIG. 6, process 600 may include processing, after processing the data using the feature extraction engine, the data using a transformation engine to reduce a size of the data (block 640). For example, the procurement analysis platform (e.g., using computing resource 334, processor 420, and/or the like) may process, after processing the data using the feature extraction engine, the data using a transformation engine to reduce a size of the data, as described above.

As further shown in FIG. 6, process 600 may include processing, after processing the data using the transformation engine, the data using a set of machine learning models, wherein the set of machine learning models is related to at least one of: categorizing each of the multiple invoices, each of the multiple requisitions, or each of the multiple projects into one or more of multiple categories associated with operations of the organization, identifying a set of possible suppliers for each of the multiple requisitions or each of the multiple projects, or identifying a set of similar projects for each of the multiple projects (block 650). For example, the procurement analysis platform (e.g., using computing resource 334, processor 420, and/or the like) may process, after processing the data using the transformation engine, the data using a set of machine learning models, as described above. In some implementations, the set of machine learning models is related to at least one of: categorizing each of the multiple invoices, each of the multiple requisitions, or each of the multiple projects into one or more of multiple categories associated with operations of the organization, identifying a set of possible suppliers for each of the multiple requisitions or each of the multiple projects, or identifying a set of similar projects for each of the multiple projects.

As further shown in FIG. 6, process 600 may include determining a score for the data based on output from the set of machine learning models, wherein the score identifies the one or more of the multiple categories, the set of possible suppliers, or the set of similar projects (block 660). For example, the procurement analysis platform (e.g., using computing resource 334, processor 420, and/or the like) may determine a score for the data based on output from the set of machine learning models, as described above. In some implementations, the score identifies the one or more of the multiple categories, the set of possible suppliers, or the set of similar projects.

As further shown in FIG. 6, process 600 may include performing, after determining the score, one or more actions (block 670). For example, the procurement analysis platform (e.g., using computing resource 334, processor 420, memory 430, storage component 440, input component 450, output component 460, communication interface 470, and/or the like) may perform, after determining the score, one or more actions, as described above.

Process 600 may include additional implementations, such as any single implementation or any combination of implementations described below and/or in connection with one or more other processes described elsewhere herein.

In some implementations, the feature extraction engine uses, to process the data, at least one of: a normalization technique, a tokenization technique, a text-based numeric features modeling technique, or a latent feature modeling technique. In some implementations, the transformation engine uses, to process the data, at least one of: a weak classifier technique, or a dimensionality reduction technique.

In some implementations, the procurement analysis platform may identify a subset of the data to be analyzed based on a set of terms included in the data. In some implementations, the procurement analysis platform may normalize, after identifying the subset of the data, the subset of the data to a set of pre-determined terms by mapping the set of terms to the set of pre-determined terms.

In some implementations, the procurement analysis platform may classify the data into one or more classifications after processing the data using the feature extraction engine, wherein the one or more classifications are associated with generalizing the data. In some implementations, the procurement analysis platform may process the data using a hash function after processing the data using the feature extraction engine, wherein the hash function is associated with compressing the data.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

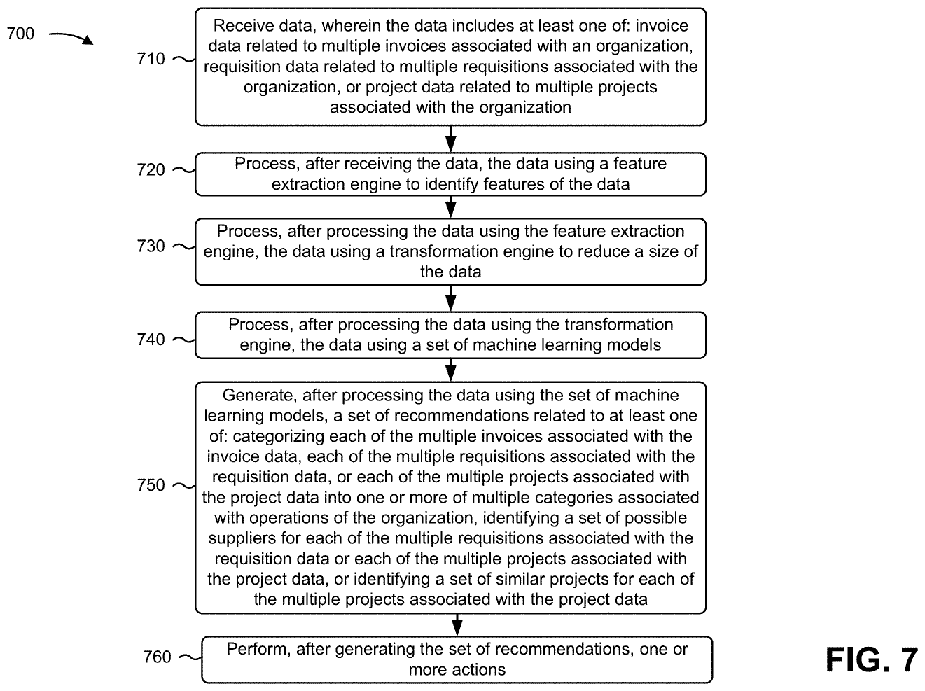

FIG. 7 is a flow chart of an example process 700 for performing machine learning-based analysis using a machine learning-based platform. In some implementations, one or more process blocks of FIG. 7 may be performed by a procurement analysis platform (e.g., procurement analysis platform 330). In some implementations, one or more process blocks of FIG. 7 may be performed by another device or a group of devices separate from or including the procurement analysis platform, such as a client device (e.g., client device 310), a server device (e.g., server device 320), and a computing resource (e.g., computing resource 334).

As shown in FIG. 7, process 700 may include receiving data, wherein the data includes at least one of: invoice data related to multiple invoices associated with an organization, requisition data related to multiple requisitions associated with the organization, or project data related to multiple projects associated with the organization (block 710). For example, the procurement analysis platform (e.g., using computing resource 334, processor 420, input component 450, communication interface 470, and/or the like) may receive data, as described above. In some implementations, the data includes at least one of: invoice data related to multiple invoices associated with an organization, requisition data related to multiple requisitions associated with the organization, or project data related to multiple projects associated with the organization.

As further shown in FIG. 7, process 700 may include processing, after receiving the data, the data using a feature extraction engine to identify features of the data (block 720). For example, the procurement analysis platform (e.g., using computing resource 334, processor 420, and/or the like) may process, after receiving the data, the data using a feature extraction engine to identify features of the data, as described above.

As further shown in FIG. 7, process 700 may include processing, after processing the data using the feature extraction engine, the data using a transformation engine to reduce a size of the data (block 730). For example, the procurement analysis platform (e.g., using computing resource 334, processor 420, and/or the like) may process, after processing the data using the feature extraction engine, the data using a transformation engine to reduce a size of the data, as described above.

As further shown in FIG. 7, process 700 may include processing, after processing the data using the transformation engine, the data using a set of machine learning models (block 740). For example, the procurement analysis platform (e.g., using computing resource 334, processor 420, and/or the like) may process, after processing the data using the transformation engine, the data using a set of machine learning models, as described above.

As further shown in FIG. 7, process 700 may include generating, after processing the data using the set of machine learning models, a set of recommendations related to at least one of: categorizing each of the multiple invoices associated with the invoice data, each of the multiple requisitions associated with the requisition data, or each of the multiple projects associated with the project data into one or more of multiple categories associated with operations of the organization, identifying a set of possible suppliers for each of the multiple requisitions associated with the requisition data or each of the multiple projects associated with the project data, or identifying a set of similar projects for each of the multiple projects associated with the project data (block 750). For example, the procurement analysis platform (e.g., using computing resource 334, processor 420, and/or the like) may generate, after processing the data using the set of machine learning models, a set of recommendations related to at least one of: categorizing each of the multiple invoices associated with the invoice data, each of the multiple requisitions associated with the requisition data, or each of the multiple projects associated with the project data into one or more of multiple categories associated with operations of the organization, identifying a set of possible suppliers for each of the multiple requisitions associated with the requisition data or each of the multiple projects associated with the project data, or identifying a set of similar projects for each of the multiple projects associated with the project data, as described above.

As further shown in FIG. 7, process 700 may include performing, after generating the set of recommendations, one or more actions (block 760). For example, the procurement analysis platform (e.g., using computing resource 334, processor 420, memory 430, storage component 440, input component 450, output component 460, communication interface 470, and/or the like) may perform, after generating the set of recommendations, one or more actions, as described above.

Process 700 may include additional implementations, such as any single implementation or any combination of implementations described below and/or in connection with one or more other processes described elsewhere herein.

In some implementations, the procurement analysis platform may determine a set of scores for each of the multiple invoices, each of the multiple requisitions, or each of the multiple projects based on output from the set of machine learning models, wherein the set of scores indicates at least one of: the one or more of the multiple categories into which each of the multiple invoices are to be categorized, the set of possible suppliers for each of the requisitions or each of the set of similar projects, or the set of similar projects for each of the multiple projects. In some implementations, the procurement analysis platform may perform an analysis related to the multiple invoices, may send a message to a system to place an order for one or more items associated with the multiple requisitions, or may send a message to a device associated with an individual associated with a project, of the multiple projects, wherein the message includes information that identifies the set of similar projects.

In some implementations, the procurement analysis platform may identify a subset of the data to be analyzed based on a set of terms identified in the data; and may normalize, after identifying the subset of the data, the subset of the data to a set of pre-determined terms by mapping the terms to the set of pre-determined terms. In some implementations, the procurement analysis platform may classify the data into one or more classifications after processing the data using the feature extraction engine, wherein the one or more classifications are associated with generalizing the data, and may process, in association with classifying the data, the data using a hash function, wherein the hash function is associated with compressing the data. In some implementations, the procurement analysis platform may receive the set of machine learning models from a server device prior to processing the data using the set of machine learning models.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, and/or a combination of hardware and software.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, data,
wherein the data includes at least one of:
invoice data related to multiple invoices associated with an organization,
requisition data related to multiple requisitions associated with the organization, or
project data related to multiple projects associated with the organization;
processing, by the device and after receiving the data, the data using a pre-processing technique,
wherein the pre-processing technique includes at least one of:
an image processing technique, or
a text processing technique;
processing, by the device and after processing the data using the pre-processing technique, the data using a feature extraction engine to identify features of the data;
processing, by the device and after processing the data using the feature extraction engine, the data using a transformation engine to reduce a size of the data;
processing, by the device and after processing the data using the transformation engine, the data using a set of machine learning models,
wherein the set of machine learning models is related to at least one of:
categorizing each of the multiple invoices associated with the invoice data, each of the multiple requisitions associated with the requisition data, or each of the multiple projects associated with the project data into one or more of multiple categories associated with operations of the organization,
identifying a set of possible suppliers for each of the multiple requisitions associated with the requisition data or each of the multiple projects associated with the project data, or
identifying a set of similar projects for each of the multiple projects associated with the project data; and
performing, by the device and after processing the data using the set of machine learning models, one or more actions.

2. The method of claim 1, further comprising:
determining a set of scores for each of the multiple invoices, each of the multiple requisitions, or each of the multiple projects based on output from the set of machine learning models,
wherein the set of scores indicates at least one of:
the one or more of the multiple categories into which each of the multiple invoices, each of the multiple requisitions, or each of the multiple projects are to be categorized,
the set of possible suppliers for each of the multiple requisitions or each of the multiple projects, or
the set of similar projects for each of the multiple projects.

3. The method of claim 2, further comprising:
generating, based on the set of scores, a set of recommendations related to at least one of:
categorizing the multiple invoices,
identifying the set of possible suppliers,
identifying the set of similar projects, or
performing the one or more actions.

4. The method of claim 1, wherein the set of machine learning models includes at least one of:
a gradient boosting machine learning model, or
a generalized linear model.

5. The method of claim 1, wherein performing the one or more actions comprises:
generating a report that includes information identifying at least one of:
the one or more of the multiple categories,
the set of possible suppliers, or
the set of similar projects; and
outputting, after generating the report, the report for display via a client device.

6. The method of claim 1, wherein performing the one or more actions comprises:
selecting a supplier, of the set of possible suppliers, based on a respective score associated with the set of possible suppliers,
wherein the respective score is output from the set of machine learning models; and
sending, to a procurement system associated with the supplier, an electronic order for one or more items after selecting the supplier.

7. The method of claim 6, wherein performing the one or more actions comprises:
sending, to a vehicle associated with delivering the one or more items, information that identifies a delivery location for the one or more items.

8. A device, comprising:
one or more memories; and
one or more processors, communicatively coupled to the one or more memories, to:
receive data,
wherein the data is related to multiple invoices, multiple requisitions, or multiple projects associated with an organization;
process, after receiving the data, the data using a pre-processing technique,
wherein the pre-processing technique includes at least one of:
an image process technique, or
a text process technique;
process, after processing the data using the pre-processing technique, the data using a feature extraction engine to identify features of the data;
process, after processing the data using the feature extraction engine, the data using a transformation engine to reduce a size of the data;
process, after processing the data using the transformation engine, the data using a set of machine learning models,
wherein the set of machine learning models is related to at least one of:
categorizing each of the multiple invoices, each of the multiple requisitions, or each of the multiple projects into one or more of multiple categories associated with operations of the organization,
identifying a set of possible suppliers for each of the multiple requisitions or each of the multiple projects, or
identifying a set of similar projects for each of the multiple projects;
determine a score for the data based on output from the set of machine learning models,
wherein the score identifies the one or more of the multiple categories, the set of possible suppliers, or the set of similar projects; and
perform, after determining the score, one or more actions.

9. The device of claim 8, wherein the feature extraction engine uses, to process the data, at least one of:
a normalization technique,
a tokenization technique,
a text-based numeric features modeling technique, or
a latent feature modeling technique.

10. The device of claim 8, wherein the transformation engine uses, to process the data, at least one of:
a weak classifier technique, or
a dimensionality reduction technique.

11. The device of claim 8, wherein the one or more processors, when processing the data using the feature extraction engine, are to:
identify a subset of the data to be analyzed based on a set of terms included in the data.

12. The device of claim 11, wherein the one or more processors, when processing the data using the feature extraction engine, are to:
normalize, after identifying the subset of the data, the subset of the data to a set of pre-determined terms by mapping the set of terms to the set of pre-determined terms.

13. The device of claim 8, wherein the one or more processors, when processing the data using the transformation engine, are to:
classify the data into one or more classifications after processing the data using the feature extraction engine,
wherein the one or more classifications are associated with generalizing the data.

14. The device of claim 8, wherein the one or more processors, when processing the data using the transformation engine, are to:
process the data using a hash function after processing the data using the feature extraction engine,
wherein the hash function is associated with compressing the data.

15. A non-transitory computer-readable medium storing instructions, the instructions comprising:
one or more instructions that, when executed by one or more processors, cause the one or more processors to:
receive data,
wherein the data includes at least one of:
invoice data related to multiple invoices associated with an organization,
requisition data related to multiple requisitions associated with the organization, or
project data related to multiple projects associated with the organization;
process, after receiving the data, the data using a feature extraction engine to identify features of the data;
process, after processing the data using the feature extraction engine, the data using a transformation engine to reduce a size of the data;
process, after processing the data using the transformation engine, the data using a set of machine learning models;
generate, after processing the data using the set of machine learning models, a set of recommendations related to at least one of:
categorizing each of the multiple invoices associated with the invoice data, each of the multiple requisitions associated with the requisition data, or each of the multiple projects associated with the project data into one or more of multiple categories associated with operations of the organization,
identifying a set of possible suppliers for each of the multiple requisitions associated with the requisition data or each of the multiple projects associated with the project data, or
identifying a set of similar projects for each of the multiple projects associated with the project data; and
perform, after generating the set of recommendations, one or more actions.

16. The non-transitory computer-readable medium of claim 15, wherein the one or more instructions, when executed by the one or more processors, further cause the one or more processors to:
determine a set of scores for each of the multiple invoices, each of the multiple requisitions, or each of the multiple projects based on output from the set of machine learning models,
wherein the set of scores indicates at least one of:
the one or more of the multiple categories into which each of the multiple invoices are to be categorized,
the set of possible suppliers for each of the requisitions or each of the set of similar projects, or
the set of similar projects for each of the multiple projects.

17. The non-transitory computer-readable medium of claim 15, wherein the one or more instructions, that cause the one or more processors to perform the one or more actions, cause the one or more processors to:
perform an analysis related to the multiple invoices,
send a message to a system to place an order for one or more items associated with the multiple requisitions, or
send a message to a device associated with an individual associated with a project, of the multiple projects,
wherein the message includes information that identifies the set of similar projects.

18. The non-transitory computer-readable medium of claim 15, wherein the one or more instructions, that cause the one or more processors to process the data using the feature extraction engine, cause the one or more processors to:
identify a subset of the data to be analyzed based on a set of terms identified in the data; and
normalize, after identifying the subset of the data, the subset of the data to a set of pre-determined terms by mapping the terms to the set of pre-determined terms.

19. The non-transitory computer-readable medium of claim 15, wherein the one or more instructions, that cause the one or more processors to process the data using the transformation engine, cause the one or more processors to:
classify the data into one or more classifications after processing the data using the feature extraction engine,
wherein the one or more classifications are associated with generalizing the data; and
process, in association with classifying the data, the data using a hash function,
wherein the hash function is associated with compressing the data.

20. The non-transitory computer-readable medium of claim 15, wherein the one or more instructions, when executed by the one or more processors, further cause the one or more processors to:
receive the set of machine learning models from a server device prior to processing the data using the set of machine learning models.
